(19) United States
(12) Patent Application Publication
(10) Pub. No.: US 2020/0304636 A1
(43) Pub. Date: Sep. 24, 2020

(54) Proxy Virtual Agent for Issue Resolution

(71) Applicant: International Business Machines Corporation, Armonk, NY (US)

(72) Inventors: Craig M. Trim, Ventura, CA (US); Lakisha R. Hall, Upper Marlboro, MD (US); Gandhi Sivakumar, Bentleigh (AU); Kushal Patel, Pune (IN); Sarvesh S. Patel, Pune (IN)

(21) Appl. No.: 16/357,450

(22) Filed: Mar. 19, 2019

(51) Int. Cl. H04M 3/493; G06F 3/16; H04L 29/08; G06F 9/451

(52) U.S. Cl. CPC H04M 3/493; G06F 3/167; G06F 9/453; H04L 67/14; H04L 67/28

(57) ABSTRACT

Automatically structuring communication with a customer support center is provided. A set of user interactions with a mobile device is received. An interactive voice response system is automatically routed through based on the received set of user interactions with the mobile device.

### BACKGROUND

### 1. Field

The disclosure relates generally to virtual personal agents and more specifically to providing a proxy virtual agent to automatically structure communication with a virtual assistant or interactive voice response system of a customer support center to resolve an issue experienced by a user of a mobile device.

### 2. Description of the Related Art

A virtual personal agent is a software application or program on a mobile data processing system or device, such as, for example, a smart phone, that performs tasks or services for a user. A user may prompt a virtual personal agent by using, for example, text or voice inputs. Virtual personal agents use natural language processing to match a text or voice input to executable commands. Virtual personal agents may be built into an operating system (OS) of the mobile data processing system or may be built independent of the OS. Virtual personal agents can provide a wide variety of services based on user input, location awareness, and an ability to access information from a variety of online sources, such as, for example, weather and traffic conditions, news reports, stock prices, retail prices, and the like. Virtual personal agents can also perform a variety of tasks, such as, for example, set an alarm, make a to-do list, make a shopping list, play music, play a movie or TV show, and the like.

### SUMMARY

According to one illustrative embodiment, a method for automatically structuring communication with a customer support center is provided. A proxy virtual agent receives a set of user interactions with a mobile device. The proxy virtual agent automatically routes through an interactive voice response system based on the received set of user interactions with the mobile device. According to other illustrative embodiments, a mobile device and computer program product for automatically structuring communication with a customer support center are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a proxy virtual agent deployed on a mobile device in accordance with an illustrative embodiment;

FIG. 4 is a diagram illustrating an example of a proxy virtual agent deployed as an online service in accordance with an illustrative embodiment;

FIGS. 5A-5B illustrate a specific example of an interactive voice response tree in accordance with an illustrative embodiment;

FIG. 6 is a flowchart illustrating a process for automatic conversation between a proxy virtual agent and a customer support center virtual assistant in accordance with an illustrative embodiment; and

FIG. 7 is a flowchart illustrating a process for automatic communication between a proxy virtual agent and a customer support center interactive voice response system in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

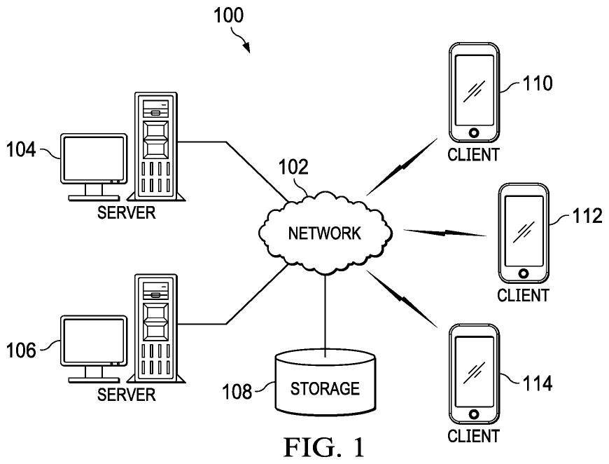

With reference now to the figures, and in particular, with reference to FIGS. 1-4, diagrams of data processing environments are provided in which illustrative embodiments may be implemented. It should be appreciated that FIGS. 1-4 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 may be included in one or more customer support centers that provide customer support services to client device users. Further, server 104 and server 106 may include a virtual assistant and/or an interactive voice response (IVR) system to assist client device users with queries and problems.

A virtual assistant is an engineered intelligent entity residing in software that interfaces with humans in a human way. The virtual assistant incorporates elements of IVR and other artificial intelligence systems to deliver a virtual entity that converses with client device users in natural language. IVR is a telephony technology that can understand a combination of touch tone inputs via a keypad and voice inputs via a microphone. An IVR system provides client device users with an ability to access a database of information via telephone. A typical IVR system has several menus of prerecorded options that the user can choose from. While many options are as basic as choosing a number, some options may require the user to speak detailed information such as user name or account information. This input is understood by the IVR system and is used to access the appropriate information in the database. Also, the IVR system may dynamically generate audio to further direct client device users on how to proceed.

Also, it should be noted that server 104 and server 106 may each represent a cluster of servers in one or more data centers. Alternatively, server 104 and server 106 may each represent a plurality of computing nodes in one or more cloud environments that manage customer support services for different entities, such as companies, enterprises, organizations, agencies, institutions, and the like.

Client 110, client 112, and client 114 also connect to network 102. Clients 110, 112, and 114 are clients of server 104 and server 106. In this example, clients 110, 112, and 114 are shown as mobile devices, such as smart phones, with wireless communication links to network 102. However, it should be noted that clients 110, 112, and 114 are examples only and may represent other types of mobile data processing systems, such as, for example, laptop computers, tablet computers, smart watches, gaming devices, and the like, with wireless communication links to network 102. Users of clients 110, 112, and 114 may utilize clients 110, 112, and 114 to access and utilize the customer support services provided by server 104 and server 106.

Moreover, clients 110, 112, and 114 may include a proxy virtual agent that automatically composes and structures communications with a virtual assistant or IVR system of the customer support center to resolve issues experienced by users of clients 110, 112, and 114 based on recorded user interactions with clients 110, 112, and 114 and identified characteristics of the recorded user interactions generated by the proxy virtual agent. Furthermore, the proxy virtual agent may include a machine learning component that learns user interaction patterns, application specific keywords, user-experienced issues, issue resolution steps, and the like for future reference.

Storage 108 is a network storage device capable of storing any type of data in a structured format or an unstructured format. In addition, storage 108 may represent a plurality of network storage devices. Further, storage 108 may store identifiers and network addresses for a plurality of servers, identifiers and network addresses for a plurality of different client devices, identifiers for a plurality of different users, user/mobile device interaction data, user profiles, and the like. Furthermore, storage 108 may store other types of data, such as authentication or credential data that may include user names, passwords, and biometric data associated with users and system administrators, for example.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, a telecommunications network, an internet, a wide area network (WAN), an intranet, a local area network (LAN), or any combination thereof. FIG. 1 is intended as an example only, and not as an architectural limitation for the different illustrative embodiments.

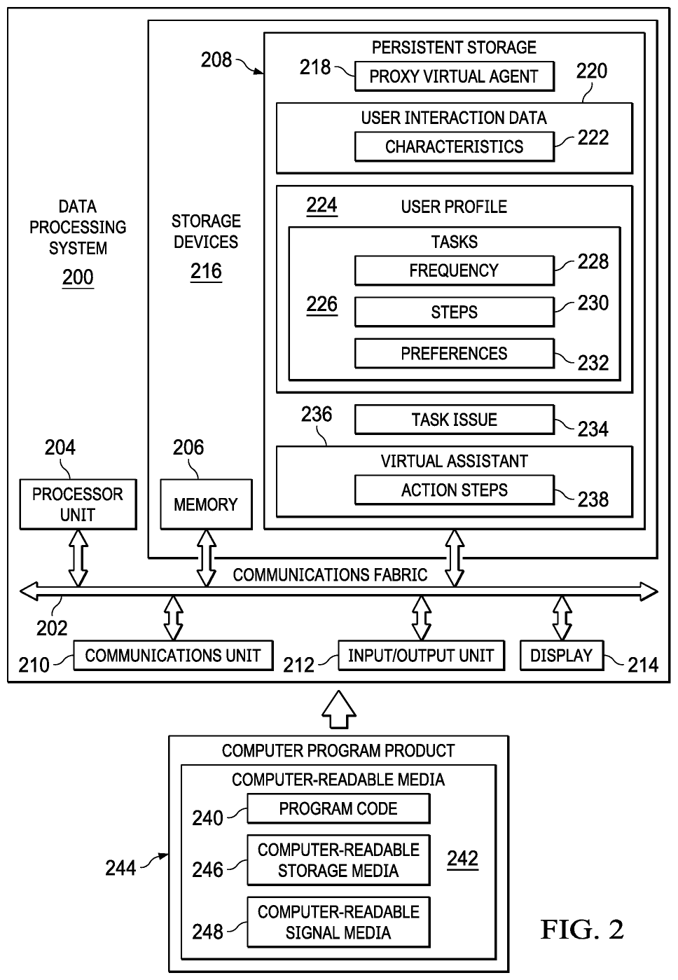

With reference now to FIG. 2, a diagram of a data processing system is depicted in accordance with an illustrative embodiment. Data processing system 200 is an example of a mobile device, such as client 110 in FIG. 1, in which computer readable program code or instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random-access memory (RAM), or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, or some combination of the above.

In this example, persistent storage 208 stores proxy virtual agent 218. However, it should be noted that even though proxy virtual agent 218 is illustrated as residing in persistent storage 208, in an alternative illustrative embodiment proxy virtual agent 218 may be a separate component of data processing system 200. For example, proxy virtual agent 218 may be a hardware component coupled to communication fabric 202 or a combination of hardware and software components.

Proxy virtual agent 218 controls the process of automatically composing and structuring communications with a customer support center virtual assistant and/or IVR system to assist the virtual assistant or IVR system in resolving issues experienced by a user of data processing system 200 without user input or involvement based on interactions by the user with data processing system 200 and characteristics of those user interactions collected and recorded by proxy virtual agent 218. User interaction data 220 represent information corresponding to interactions by the user with data processing system 200. User interaction data 220 may include both current and historic user interaction information. Characteristics 222 represent attributes and features of user interaction data 220. Characteristics 222 may include, for example, active application currently displayed on display 214, number of times the user performed a particular user interaction with the active application, day of week and time when the user performed that particular user interaction with the active application, time required by the user to perform that particular user interaction with the active application, user frustration level while performing that particular user interaction with the active application based on camera images of the user, user voice inputs, and user textual inputs, and the like.

User profile 224 represents a stored profile corresponding to the user of data processing system 200. User profile 224 may contain information such as name, unique identifier, birth date, home address, employer, title, work address, hobbies, demographic information, and the like corresponding to the user. In this example, user profile 224 also includes tasks 226. Tasks 226 represent a plurality of tasks that the user is currently performing or has previously performed on data processing system 200. Tasks 226 include frequency 228, steps 230, and preferences 232. Frequency 228 represents how often or the regularity with which the user performs each particular task in tasks 226. Steps 230 represent the number and type of actions or activities the user performs on data processing system 200 to execute each particular task in tasks 226. Preferences 232 represent user-defined policies or rules for sharing which information and how much information corresponding to the user with entities associated with particular tasks in tasks 226.

Task issue 234 represents an issue or problem that the user of data processing system 200 is currently experiencing while performing a particular task on data processing system 200. Proxy virtual agent 218 detects task issue 234 based on information in user interaction data 220, characteristics 222, and user profile 224.

Proxy virtual agent 218 automatically contacts virtual assistant 236 to resolve task issue 234. Virtual assistant 236 represents an identifier of a virtual assistant of a customer support center that corresponds to task issue 234. Virtual assistant 236 may be located in a server, such as server 104 in FIG. 1, of the customer support center.

Moreover, proxy virtual agent 218 automatically composes and structures a conversation with virtual assistant 236 without input from the user of data processing system 200 based on analysis of collected information corresponding to user interaction data 220, characteristics 222, and user profile 224 and detected task issue 234. Proxy virtual agent 218 composes and structures the conversation with virtual assistant 236 to assist virtual assistant 236 to quickly retrieve the appropriate information to resolve task issue 234. Based on the structured conversation with proxy virtual agent 218 regarding task issue 234, virtual assistant 236 retrieves and sends action steps 238 to proxy virtual agent 218. Action steps 238 represent a set of one or more steps to resolve task issue 234. Upon receiving action steps 238 from virtual assistant 236, proxy virtual agent 218 automatically executes action steps 238 to resolve task issue 234. Alternatively, proxy virtual agent 218 may display action steps 238 to the user and request, via a pop up for example, authorization to execute action steps 238 automatically to resolve task issue 234.

Communications unit 210, in this example, provides for communication with other computers, data processing systems, and devices via a network, such as network 102 in FIG. 1. Communications unit 210 may provide communications through the use of both wireless and physical communications links. The wireless communications link may utilize, for example, shortwave, high frequency, ultra high frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200. 5G mobile communications succeed 4G, 3G, and 2G systems. 5G performance includes higher data rates to move more data, reduced latency to be more responsive, increased energy savings, cost reductions, higher system capacity, and greater device connectivity to service more devices at the same time. The physical communications link may utilize, for example, a wire, cable, universal serial bus, or any other physical technology to establish a physical communications link for data processing system 200.

Input/output unit 212 allows for the input and output of data with other devices that may be connected to data processing system 200. For example, input/output unit 212 may provide a connection for user input through a keypad, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 240 is located in a functional form on computer readable media 242 that is selectively removable and may be loaded onto or transferred to data processing system 200 for running by processor unit 204. Program code 240 and computer readable media 242 form computer program product 244. In one example, computer readable media 242 may be computer readable storage media 246 or computer readable signal media 248. Computer readable storage media 246 may include, for example, an optical or magnetic disc that is inserted or placed into a drive or other device that is part of persistent storage 208 for transfer onto a storage device, such as a hard drive, that is part of persistent storage 208. Computer readable storage media 246 also may take the form of a persistent storage, such as a hard drive, a thumb drive, or a flash memory that is connected to data processing system 200. In some instances, computer readable storage media 246 may not be removable from data processing system 200.

Alternatively, program code 240 may be transferred to data processing system 200 using computer readable signal media 248. Computer readable signal media 248 may be, for example, a propagated data signal containing program code 240. For example, computer readable signal media 248 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 240 may be downloaded over a network to persistent storage 208 from another device or data processing system through computer readable signal media 248 for use within data processing system 200. For instance, program code stored in a computer readable storage media in a data processing system may be downloaded over a network from the data processing system to data processing system 200. The data processing system providing program code 240 may be a server computer, a client computer, or some other device capable of storing and transmitting program code 240.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 246 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Modern mobile devices are equipped with operating systems that are capable of serving users with a high degree of satisfaction. Introduction of cognition-enabled capabilities into these mobile devices makes these mobile devices even more user friendly. Also, with the addition of natural language processing, these mobile devices are capable of processing natural language commands. Typically, operating systems record user activities for various reasons, such as, for example, managing insights and building a knowledgebase for supervised cognitive machine learning applications. These recordings of user activities include information about the user, as well as, information regarding user interactions with the mobile device and corresponding timestamps.

Artificial intelligence systems are evolving to solve a variety of problems. For example, virtual assistants may simulate human-oriented tasks in solving problems in a business or social environment. Virtual assistants may include, for example, those virtual assistants for assisting end users in installing or trouble shooting information technology systems that deliver business capabilities and those virtual assistants able to provide assistance to other types of end users, such as banking customers calling a call center for account management assistance. Virtual assistants deployed to serve customers in the banking industry perform various types of transactions, such as, for example, fund transfers, balance inquiries, and the like.

Illustrative embodiments provide a mobile device-based user interaction monitoring proxy virtual agent that assists a user when communicating with a customer support center virtual assistant and avoid user intervention to provide repetitive information while reporting issues or problems to the customer support center using the user interaction monitoring proxy virtual agent on the mobile device. Illustrative embodiments continuously collect data regarding user interaction with the mobile device and automatically generate, compose, assemble, arrange, structure, or frame conversation points based on continuing communication with the customer support center virtual assistant. Illustrative embodiments structure conversations with the customer support center virtual assistant using the user interaction monitoring proxy virtual agent on the mobile device. In addition, illustrative embodiments utilize the structured conversations with the customer support center virtual assistant to assist the virtual assistant in resolving user issues or problems. Further, it should be noted that illustrative embodiments may be implemented as a service in a 5G telecommunications network instead of on a mobile device.

As an example scenario, a user is initiating a banking transaction from a mobile device. However, the banking transaction is not completing because of some technical issue, which may be an application error or server error, and the user's bank account is now locked due to multiple failed transaction attempts. When the user initiates communication with a customer support center corresponding to the bank, a customer support center virtual assistant asks the user for details that the user already provided while making the multiple transaction attempts using the mobile device. In this example scenario, the user has to repetitively provide details and information to the customer support center virtual assistant, which results in an unpleasant user experience. Further, if the banking application on the mobile device is new to the user, then the user may be unfamiliar with the data fields in the banking application and this may result in an even more unpleasant user experience.

When any issue or problem with a server or application arises, no current solution exists where user/mobile device interaction data are gathered while the user is performing tasks or activities on the mobile device and where that user/mobile device interaction data can be used to structure a conversation with a customer support center virtual assistant for resolution of the issue or problem. Also, no current solution exists that monitors user activity, traces the user activity, and stores that user activity data, which can then be automatically supplied to a customer support center virtual assistant or interactive voice response (IVR) system to prevent the user from having to provide redundant information demanded by the customer support center virtual assistant or IVR system. In addition, no current solution exists that automatically traverses an IVR tree to appropriately route a call to the customer support center to the correct IVR node or customer support personnel for resolution.

Customer support center virtual assistants are widely used in many industries, such as the banking industry, where the virtual assistants are used to interact with customers for account related queries and transactions. The virtual assistants work as representatives of the entity (e.g., bank) and collaborate with the customers to answer queries and resolve issues. Illustrative embodiments provide a proxy virtual agent in mobile devices that co-exists with mobile applications and operating systems. This proxy virtual agent monitors and records user interactions with the mobile device (e.g., steps performed by a user to execute a particular task using the mobile device) and identifies characteristics, attributes, or features of the user interactions. In other words, illustrative embodiments trace the user interactions with the mobile device while the user is performing a set of tasks on the user's mobile device and assist the customer support center virtual assistant (e.g., chatbot) to answer the user's query or resolve the user's problem or issue quickly. Based on recorded user interactions with the mobile device, information stored in a user profile, and user-enabled level of data collection by the proxy virtual agent on the mobile device, the proxy virtual agent composes and structures the conversation with the customer support center virtual assistant to facilitate quick resolution of user queries and problems. Because the recorded user interaction data contains more information and details than a customer support center virtual assistant needs or understands, the proxy virtual agent on the mobile device only extracts application specific keywords (e.g., only banking application specific keywords), to enable the customer support center virtual assistant to understand the user's query or problem faster.

Further, the proxy virtual agent in the mobile device also collaborates with existing IVR systems in customer support call centers to provide a dynamic way to automatically route a call through an IVR system to the appropriate IVR node or customer support personnel for increased issue resolution and user experience. For example, a user is experiencing an issue with bank account lock and the user initiates communication with a customer care center to resolve the issue. The customer care center's IVR system asks a number of questions to route the user's call to the appropriate IVR node or support personnel. The proxy virtual agent in the mobile device monitors the IVR system's questions and provides the appropriate answers to the IVR system's questions based on recorded user interactions with the mobile device and identified characteristics of the user interactions. Thus, the proxy virtual agent in the mobile device is able to assist the IVR system in quickly routing the user's call to the appropriate IVR node or support person that can directly address the user's query or issue. As a result, the proxy virtual agent may eliminate or decrease the need for a user to provide information repetitively to the IVR system. Further, it should be noted that the proxy virtual agent controls data collection on the mobile device and information sharing with the IVR system so that private information (e.g., user banking password and the like) is not disclosed by structuring communication with the IVR system based on historic user interaction data, extracted application specific keywords, and user-defined level of information sharing.

The proxy virtual agent in the mobile device analyzes user interactions with the mobile device to identify characteristics and attributes of the user interactions, such as, for example, frequency (i.e., hourly, daily, weekly, monthly, or the like) with which the user accesses a particular type of data or performs a particular type of task, total number of times the user performed that particular user interaction with the mobile device, time required by the user to perform that particular user interaction, user frustration levels while performing that particular user interaction based on user voice and textual inputs, and the like. The proxy virtual agent may also analyze other information such as demographic data corresponding to the user stored in a user profile. The proxy virtual agent utilizes this analyzed information to autonomously compose and structure communication and conversation with the customer support center virtual assistant to provide answers to the virtual assistant that will assist the virtual assistant in the resolution of user issues or problems without user input.

When the proxy virtual agent is remotely deployed as a service in a service orchestration layer of a 5G telecommunication network, mobile devices registered with the service transmit their respective user interaction data to the remotely deployed proxy virtual agent via a secure dedicated 5G channel of the 5G telecommunication network. The remotely deployed proxy virtual agent then analyzes the user interaction data and identifies characteristics of the user interaction data to automatically communicate with customer support center virtual assistants and IVR systems when needed by users of registered mobile devices.

The proxy virtual agent in the mobile device is capable of monitoring and recording user interactions with the mobile device and detecting the most recent user interactions with the mobile device within a defined period of time. The defined period of time may be, for example, 1 minute, 5 minutes, 10 minutes, 30 minutes, 1 hour, 1 day, or any other increment to time and may be policy-based or machine learning-based. The proxy virtual agent also is capable of leveraging the user's audio feed on the mobile device, imaging data provided by a camera on the mobile device, and other information, such as user screen touches on the mobile device, applications installed on the mobile device, and the like. The proxy virtual agent saves this information in a persistent data store.

Further, the proxy virtual agent interacts with the operating system of the mobile device to collect information regarding the active application on the mobile device's screen, user interactions with the mobile device triggered by the active application, and the like. Also, the proxy virtual agent utilizes an information collector daemon to interact with various protection ring levels of the operating system to collect the information regarding the user interactions with the mobile device based on user-defined levels of information collection.

Furthermore, the proxy virtual agent identifies characteristics and attributes of the user interactions with the mobile device and filters the information collected to detect the issue or problem the user is experiencing and to predict expected responses. The proxy virtual agent sends converted speech to text information, active application information, and other related information to a hierarchical or parallel classifier, along with an in-scope boundary definition (e.g., timelines, information privacy definitions, and the like), to identify the characteristics and attributes of the user interactions.

Moreover, the proxy virtual agent extracts application specific keywords and utilizes the extracted keywords to compose and structure a conversation so that a customer support center virtual assistant will understand the issue or problem experienced by the mobile device user in a decreased amount of time. For example, a banking transaction failure may include keywords, such as transaction timeout, insufficient funds, and the like, which the proxy virtual agent can trace from user interactions with the mobile device.

In addition, the proxy virtual agent can autonomously initiate a conversation with the customer support center virtual assistant in network operations center (NOC) mode and assist the virtual assistant in resolving the user issue or problem. A NOC is a central location from which an entity, such as a bank, supports its computer and telecommunications network, detects and resolves IT infrastructure issues, and ensures data center availability. In other words, the NOC manages infrastructure and procedural changes, events, customer calls, security, quality control and assurance, monitoring tools, ticketing systems, integration with customer tools, reporting and dashboards, and the like. In non-NOC mode, after the mobile device user initiates communication with the customer support center, the proxy virtual agent provides inputs (e.g., details regarding the user problem or issue) to the customer support center virtual assistant or IVR system for problem or issue resolution. The proxy virtual agent composes and structures the conversation to communicate the problem or issue to the customer support center virtual assistant in terms (e.g., application centric keywords) that the customer support center virtual assistant will quickly understand. The proxy virtual agent continuously monitors questions presented by the customer support center virtual assistant and modifies the conversation structuring accordingly.

The proxy virtual agent also utilizes, for example, expression maps, phrases spoken, and media stream conversions to structure the conversation content and generate corresponding metadata. In addition, the proxy virtual agent is able to automatically create a session with the appropriate node in the IVR system that will resolve the user's problem or issue.

The mobile device starts the proxy virtual agent on system boot. The mobile device loads required data structures, user interaction frequency, and other related information into the proxy virtual agent from one or more data sources. When a user is performing a set of one or more tasks on the mobile device, a data collector daemon of the proxy virtual agent continuously monitors and collects user interactions with the mobile device using multiple data streams, such as voice inputs, textual inputs, on screen touches, camera image inputs, and the like, while the user is performing the set of tasks.

If the user experiences an issue or problem while performing a particular task, then the proxy virtual agent on the mobile device contacts a customer support center corresponding to the particular task via, for example, a TCP/HTTP-based connection and establishes an online session with a virtual assistant of the customer support center. The proxy virtual agent on the mobile device initiates an information request for action steps to resolve the issue or problem using a conversation composing component of the proxy virtual agent that structures conversation with the customer support center virtual assistant without user input based on recorded user interaction data, both current and historical. The proxy virtual agent on the mobile device receives responses from the customer support center virtual assistant regarding the action steps to resolve the issue or problem.

Upon receiving the requested information regarding the action steps from the customer support center virtual assistant, the proxy virtual agent on the mobile device traverses a multilevel hierarchical data structure, such as an IVR tree, to validate permissions and, accordingly, receive action step information responses in natural language with keyword centric sentences. The proxy virtual agent on the mobile device parses and classifies the responses from the customer support center virtual assistant, applies the action steps to resolve the issue or problem, and updates the conversation composer component accordingly.

If the proxy virtual agent on the mobile device is communicating with an IVR system of the customer support center, then the proxy virtual agent on the mobile device automatically provides answers to questions posed by the IVR system to route to the appropriate IVR node or support personnel to address the issue or problem experienced by the user. In addition, the proxy virtual agent on the mobile device performs priority re-adjustment and conversation reframing based on responses from the customer support center virtual assistant. Upon receiving and applying the action step information from the customer support center virtual assistant, the proxy virtual agent on the mobile device terminates the session with the customer support center virtual assistant and learns from the entire experience using, for example, machine learning.

Thus, illustrative embodiments improve over current solutions by: 1) making a customer support center interaction faster and easier for a user; 2) preventing repetitive user input when interacting with the customer support center; 3) providing better information insights into the problem or issue experienced by the user using internal and external data; 4) dynamically composing and structuring the conversation to assist the customer support center virtual assistant or IVR system to quickly understand the problem or issue for faster resolution; 5) providing automated problem resolution in NOC mode to increase user experience; and 6) saving user time by automatically routing through an IVR system based on derived information insights.

Consequently, illustrative embodiments provide one or more technical solutions that overcome a technical problem with current virtual agents on mobile devices that are not able to automatically contact and communicate with customer support center virtual assistants and IVR systems to automatically resolve detected user issues or problems and answer user queries. As a result, these one or more technical solutions provide a technical effect and practical application in the field of virtual agents on mobile devices.

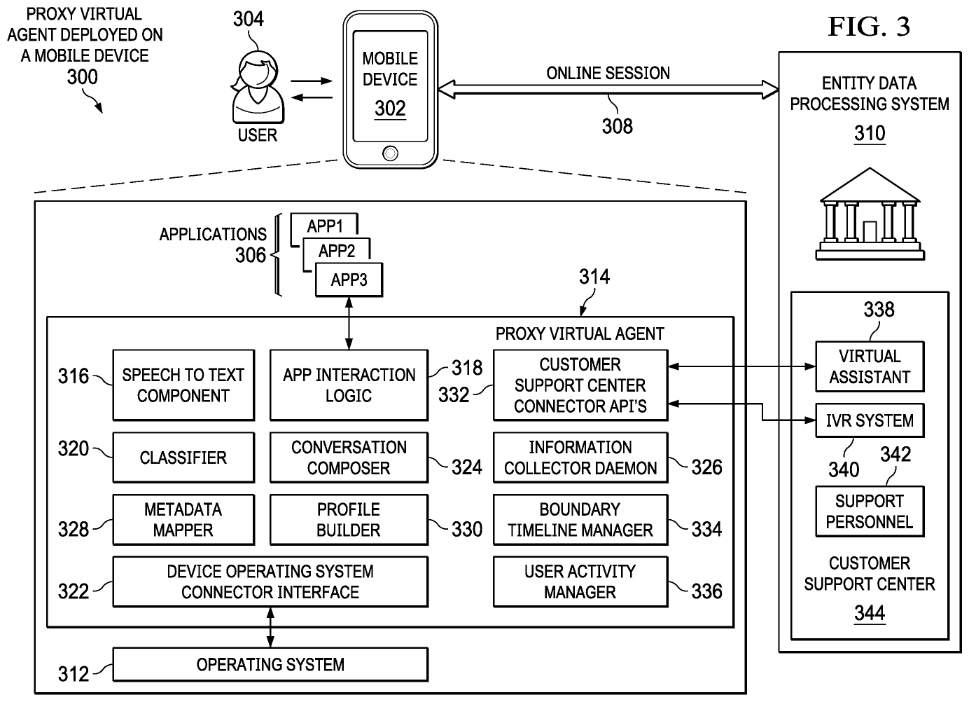

With reference now to FIG. 3, a diagram illustrating an example of a proxy virtual agent deployed on a mobile device is depicted in accordance with an illustrative embodiment. Proxy virtual agent deployed on a mobile device 300 may be implemented in a mobile device, such as mobile device 302. Mobile device 302 may be, for example, a smart phone or other similar mobile device.

User 304 of mobile device 302 utilizes an application, such as a banking application, in applications 306 to establish online session 308 with entity data processing system 310. It should be noted that applications 306 are installed on mobile device 302. Entity data processing system 310 represents a set of one or more computers, such as server 104 and server 106 in FIG. 1, corresponding to an entity, such as a bank.

In addition to applications 306, mobile device 302 also includes operating system 312 and proxy virtual agent 314. Operating system 312 manages the hardware and software resources of mobile device 302. Proxy virtual agent 314 may be, for example, proxy virtual agent 218 in FIG. 2.

In this example, proxy virtual agent 314 includes speech to text component 316, application interaction logic 318, classifier 320, device operating system connector interface 322, conversation composer 324, information collector daemon 326, metadata mapper 328, profile builder 330, customer support center connector application programming interfaces 332, boundary timeline manager 334, and user activity manager 336. However, it should be noted that proxy virtual agent 314 may include more or fewer components than illustrated. For example, one component may be split into two or more components, two or more components may be combined into one component, one or more components may be removed, or one or more components not shown may be added, such as a machine learning or artificial intelligence component, a notifier component, and the like.

Speech to text component 316 enables recognition and translation of spoken language (i.e., user voice inputs and virtual assistant responses) into text for analysis. Application interaction logic 318 provides an ability to integrate between application programming interfaces and persistent storage, such as, for example, persistent storage 208 in FIG. 2. Classifier 320 provides an ability to identify and classify personality characteristics and traits of user 304 from text, voice, and image inputs on mobile device 302 corresponding to user 304. The personality characteristics of user 304 may include traits such as openness to experience, conscientiousness, extraversion, agreeableness, neuroticism, needs, values, and the like.

Device operating system connector interface 322 provides an ability for the user to define or enable information sharing permission levels to each application in applications 306. Conversation composer 324 generates and structures conversations and communications with virtual assistant 338, IVR system 340, and support personnel 342 of customer support center 344 to assist in resolving detected issues or problems being experienced by user 304 while performing a task on mobile device 302. It should be noted that customer support center 344 is part of entity data processing system 310.

Information collector daemon 326 provides an ability to automatically access application programming interfaces and pull information and data into persistent storage. Metadata mapper 328 provides an ability to extract, transform, and load data of different types and formats. In other words, metadata mapper 328 retrieves data, transforms the retrieved data into an understandable format that meets operational needs of proxy virtual agent 314, and loads the formatted data into persistent storage.

Profile builder 330 provides an ability to generate and assemble a profile corresponding to user 304 that may include, for example, user name, user identifier, user demographics, historical user actions, activities, and tasks, user preferences, and the like. Customer support center connector application programming interfaces 332 provide an ability to connect with customer support center 344. Boundary timeline manager 334 provides an ability to manage how much information corresponding to user 304 is persisted and how that information will be used. This information management may be policy-based around timelines and privacy definitions.

User activity manager 336 provides an ability to manage all user activity and interaction information in persistent storage. The user activity and interaction information may also include metadata, such as time it took to receive a response, user sentiment, and the like. The metadata may also include a time to retrieve the user activity and interaction from persistent storage.

As soon as proxy virtual agent 314 detects that user 304 is experiencing an issue with performing a task on mobile device 302, proxy virtual agent 314 utilizes customer support center connector application programming interfaces 332 to automatically connect to virtual assistant 338 and IVR system 340 to resolve the issue. In addition, proxy virtual agent 314 utilizes conversation composer 324 to automatically structure the communication with virtual assistant 338 and IVR system 340 to quickly resolve the issue without user 304 input or involvement.

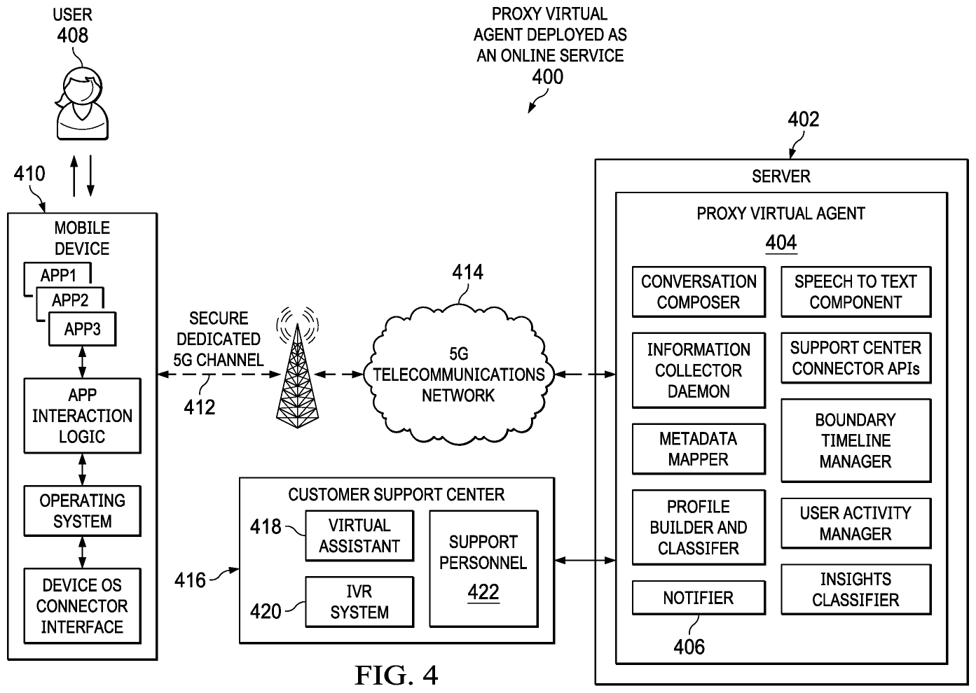

With reference now to FIG. 4, a diagram illustrating an example of a proxy virtual agent deployed as an online service is depicted in accordance with an illustrative embodiment. Proxy virtual agent deployed as an online service 400 may be implemented in a server, such as server 402. Server 402 may be, for example, server 106 in FIG. 1. Server 402 includes proxy virtual agent 404. Proxy virtual agent 404 is similar to proxy virtual agent 314 in FIG. 3, but instead of being installed on a mobile device, proxy virtual agent 404 is installed on server 402. In addition to including most of the components of proxy virtual agent 314 in FIG. 3, proxy virtual agent 404 also includes notifier 406.

In this example, user 408 performs a set of one or more tasks on mobile device 410. In addition, mobile device 410 is coupled to an E-Node B tower via secure dedicated 5G channel 412 of 5G telecommunications network 414. In turn, the E-Node B tower is coupled to server 402. It should be noted that the E-Node B tower represents a network of E-Node B towers. 5G telecommunications network 414 utilizes the E-Node B tower network to transfer data and information between mobile device 410 and server 402 via secure dedicated 5G channel 412.

Mobile device 410 sends user interaction data to server 402 for analysis by proxy virtual agent 404. If proxy virtual agent 404 detects that user 408 is experiencing an issue while performing a task on mobile device 410 based on analysis of the received user interaction data, then proxy virtual agent 404 automatically connects to customer support center 416 and establishes a session with virtual assistant 418, IVR system 420, and/or support personnel 422 to resolve the issue experienced by user 408. Proxy virtual agent 404 sends responses for resolving the issue received from virtual assistant 418, IVR system 420, and/or support personnel 422 to mobile device 410 using notifier 406.

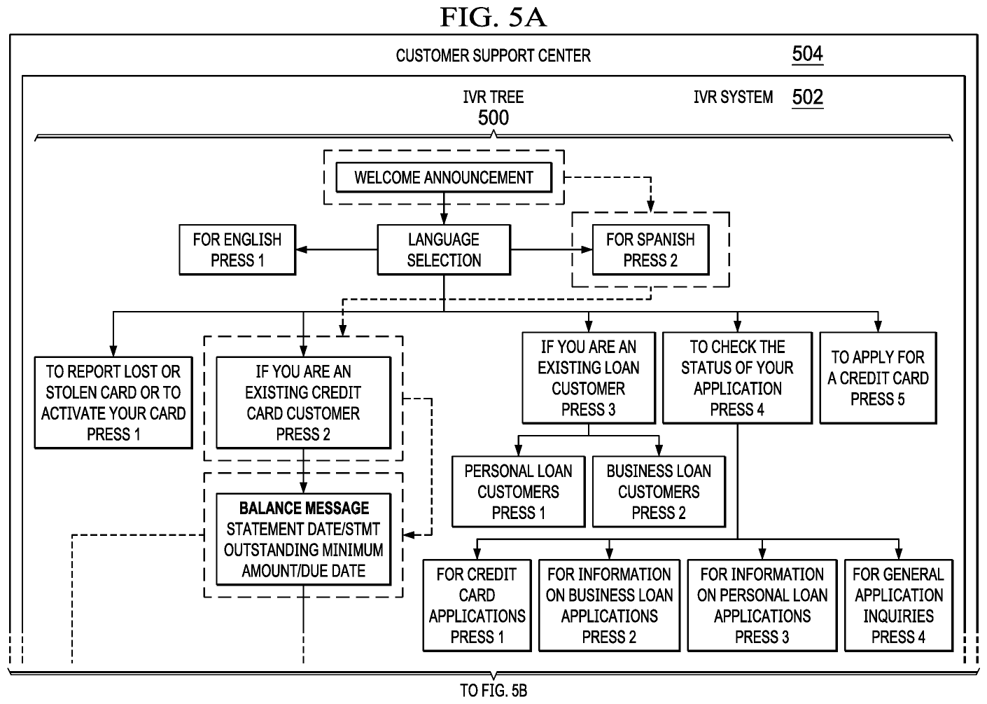

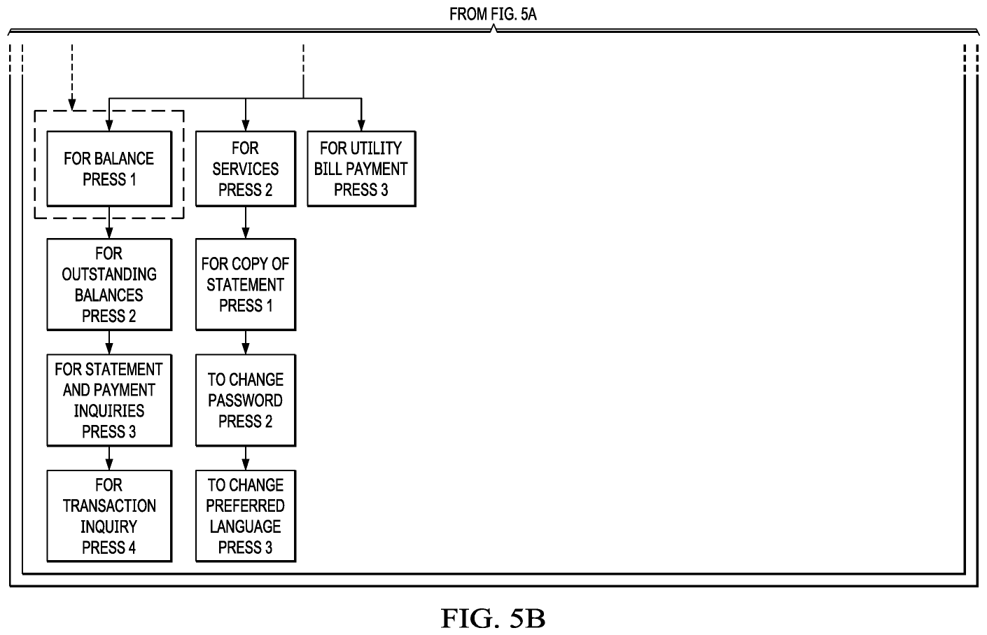

With reference now to FIGS. 5A-5B, a specific example of an IVR tree is depicted in accordance with an illustrative embodiment. IVR tree 500 represents a plurality of prerecorded options that a proxy virtual agent, such as proxy virtual agent 218 in FIG. 2, proxy virtual agent 314 in FIG. 3, or proxy virtual agent 404 in FIG. 4, can automatically traverse to resolve a user query. IVR tree 500 is implemented in IVR system 502, which is included in customer support center 504, such as IVR system 340 of customer support center 344 in FIG. 3 or IVR system 420 of customer support center 416 in FIG. 4. In this example, customer support center 504 corresponds to a banking institution.

Also in this example, a user of a mobile device, such as user 304 of mobile device 302 in FIG. 3 or user 408 of mobile device 410 in FIG. 4, wants information regarding a balance of a credit card account in Spanish. The mobile device includes a proxy virtual agent. The proxy virtual agent, based on current user interactions with the mobile device, historic user interactions, and other recorded information in a user profile, such as frequency, days, and times the user requests such information, user's language preference, and the like, automatically traverses IVR tree 500 by selecting the correct options to obtain the credit card balance in Spanish without user input.

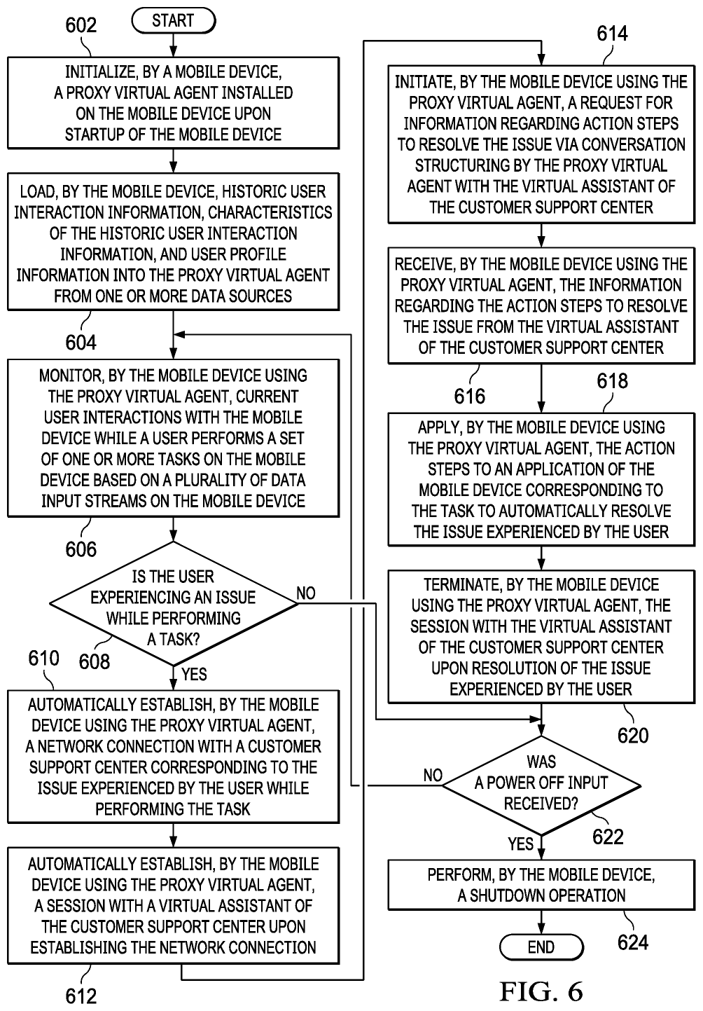

With reference now to FIG. 6, a flowchart illustrating a process for automatic conversation between a proxy virtual agent and a customer support center virtual assistant is shown in accordance with an illustrative embodiment. The process shown in FIG. 6 may be implemented in a mobile device, such as, for example, client 110 in FIG. 1, data processing system 200 in FIG. 2, or mobile device 302 in FIG. 3.

The process begins when the mobile device initializes a proxy virtual agent installed on the mobile device upon startup of the mobile device (step 602). The proxy virtual agent may be, for example, proxy virtual agent 218 in FIG. 2 or proxy virtual agent 310 in FIG. 3. The mobile device loads historic user interaction information, characteristics of the historic user interaction information, and user profile information into the proxy virtual agent from one or more data sources (step 604).

The mobile device, using the proxy virtual agent, monitors current user interactions with the mobile device while a user performs a set of one or more tasks on the mobile device based on a plurality of data input streams on the mobile device (step 606). The mobile device, using the proxy virtual agent, makes a determination as to whether the user is experiencing an issue while performing a task in the set of tasks (step 608). The proxy virtual agent makes the determination as to whether the user is experiencing an issue while performing that particular task based on the current user interactions, the historic user interactions, identified characteristics of the current and historic user interactions, and the user profile information, as well as, information obtained from the plurality of data input streams.

If the mobile device, using the proxy virtual agent, determines that the user is not experiencing an issue while performing the set of tasks, no output of step 608, then the process proceeds to step 622. If the mobile device, using the proxy virtual agent, determines that the user is experiencing an issue while performing a task in the set of tasks, yes output of step 608, then the mobile device, using the proxy virtual agent, automatically establishes a network connection with a customer support center corresponding to the issue experienced by the user while performing the task (step 610). In addition, the mobile device, using the proxy virtual agent, automatically establishes a session with a virtual assistant of the customer support center upon establishing the network connection (step 612).

Further, the mobile device, using the proxy virtual agent, initiates a request for information regarding action steps to resolve the issue via conversation structuring by the proxy virtual agent with the virtual assistant of the customer support center (step 614). Subsequently, the mobile device, using the proxy virtual agent, receives the information regarding the action steps to resolve the issue from the virtual assistant of the customer support center (step 616). The mobile device, using the proxy virtual agent, applies the action steps to an application of the mobile device corresponding to the task to automatically resolve the issue experienced by the user (step 618).

Afterward, the mobile device, using the proxy virtual agent, terminates the session with the virtual assistant of the customer support center upon resolution of the issue experienced by the user (step 620). Furthermore, the mobile device makes a determination as to whether a power off input was received (step 622). If the mobile device determines that a power off input was not received, no output of step 622, then the process returns to step 606 where the mobile device, using the proxy virtual agent, continues to monitor current user interactions with the mobile device. If the mobile device determines that a power off input was received, yes output of step 622, then the mobile device performs a shutdown operation (step 624). Thereafter, the process terminates.

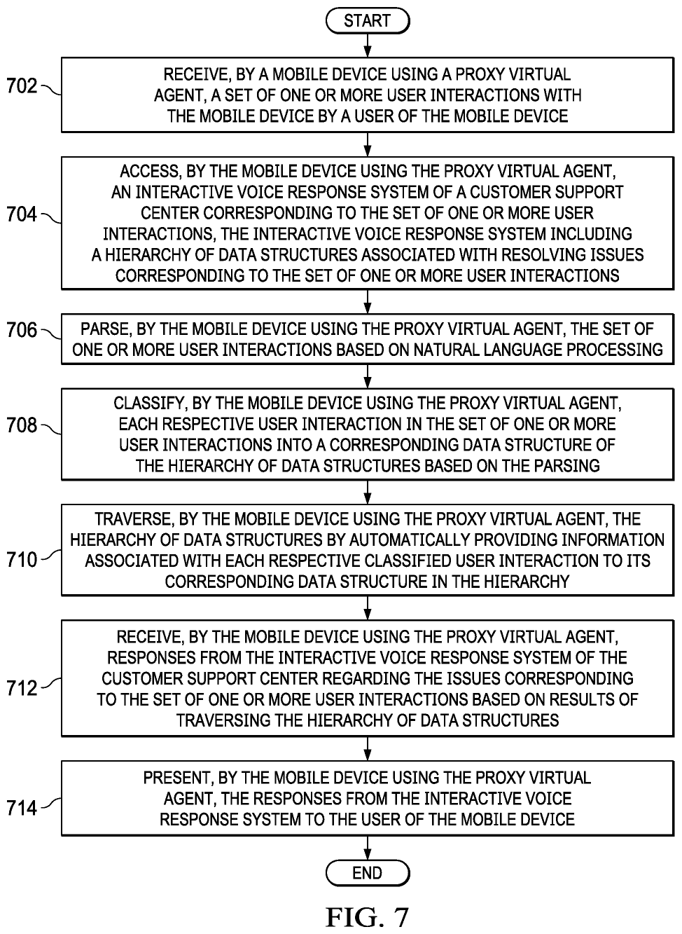

With reference now to FIG. 7, a flowchart illustrating a process for automatic communication between a proxy virtual agent and a customer support center interactive voice response system is shown in accordance with an illustrative embodiment. The process shown in FIG. 7 may be implemented in a mobile device, such as, for example, client 110 in FIG. 1, data processing system 200 in FIG. 2, or mobile device 302 in FIG. 3.

The process begins when the mobile device, using a proxy virtual agent installed on the mobile device, receives a set of one or more user interactions with the mobile device by a user of the mobile device (step 702). The mobile device, using the proxy virtual agent, access an interactive voice response system of a customer support center corresponding to the set of one or more user interactions (step 704). The interactive voice response system includes a hierarchy of data structures associated with resolving user issues or queries corresponding to the set of one or more user interactions. The hierarchy of data structures may be, for example, an IVR tree, such as IVR tree 500 in FIGS. 5A-5B.

The mobile device, using the proxy virtual agent, parses the set of one or more user interactions based on natural language processing (step 706). In addition, the mobile device, using the proxy virtual agent, classifies each respective user interaction in the set of one or more user interactions into a corresponding data structure of the hierarchy of data structures based on the parsing of the set of one or more user interactions (step 708). The proxy virtual agent may utilize, for example, a hierarchical classifier, parallel classifier, or the like, to classify each respective user interaction in the set of one or more user interactions

The mobile device, using the proxy virtual agent, traverses the hierarchy of data structures by automatically providing information associated with each respective classified user interaction to its corresponding data structure in the hierarchy (step 710). The mobile device, using the proxy virtual agent, receives responses from the interactive voice response system of the customer support center regarding the user issues or queries corresponding to the set of one or more user interactions based on results of traversing the hierarchy of data structures (step 712). The mobile device, using the proxy virtual agent, presents the responses from the interactive voice response system to the user of the mobile device (step 714). Thereafter, the process terminates.

Thus, illustrative embodiments of the present invention provide a method, mobile device, and computer program product for providing a proxy virtual agent to automatically structure communication with a virtual assistant or interactive voice response system of a customer support center to resolve an issue experienced by a user of the mobile data processing system. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
receiving, by a proxy virtual agent, a set of user interactions with a mobile device, wherein said user interactions include previously recorded user voice inputs; and
automatically composing, by the proxy virtual agent, a conversation with an interactive voice response system based on the received set of user interactions with the mobile device, wherein the proxy virtual agent is operable on the mobile device separate from the interactive voice response system.

2. The method of claim 1, wherein the automatically composing, by the proxy virtual agent, the conversation with the interactive voice response system based on the received set of user interactions with the mobile device comprises:
accessing, by the proxy virtual agent, the interactive voice response system, wherein the interactive voice response system includes a hierarchy of data structures associated with resolving issues corresponding to the set of user interactions;
parsing, by the proxy virtual agent, the set of user interactions based on natural language processing;
classifying, by the proxy virtual agent, each respective user interaction in the set of user interactions into a corresponding data structure of the hierarchy of data structures based on the parsing of the set of user interactions; and
traversing, by the proxy virtual agent, the hierarchy of data structures by automatically providing information associated with each respective classified user interaction to its corresponding data structure in the hierarchy of data structures.

3. The method of claim 2 further comprising:
receiving, by the proxy virtual agent, responses from the interactive voice response system regarding the issues corresponding to the set of user interactions based on results of the traversing of the hierarchy of data structures; and
presenting, by the proxy virtual agent, the responses from the interactive voice response system to a user of the mobile device.

4. The method of claim 1 further comprising:
monitoring, by the proxy virtual agent, current user interactions with the mobile device while a user performs a set of tasks on the mobile device using a plurality of data input streams on the mobile device; and
determining, by the proxy virtual agent, whether the user is experiencing an issue while performing a task in the set of tasks based on the current user interactions.

5. The method of claim 4 further comprising:
responsive to the proxy virtual agent determining that the user is experiencing the issue while performing the task in the set of tasks, automatically establishing, by the proxy virtual agent, a network connection with a customer support center corresponding to the issue experienced by the user while performing the task; and
automatically establishing, by the proxy virtual agent, a session with a virtual assistant of the customer support center upon establishing the network connection.

6. The method of claim 5 further comprising:
initiating, by the proxy virtual agent, a request for information regarding action steps to resolve the issue via conversation structuring by the proxy virtual agent with the virtual assistant of the customer support center;
receiving, by the proxy virtual agent, the information regarding the action steps to resolve the issue from the virtual assistant of the customer support center; and
applying, by the proxy virtual agent, the action steps to an application of the mobile device corresponding to the task to automatically resolve the issue experienced by the user.

7. The method of claim 5 further comprising:
terminating, by the proxy virtual agent, the session with the virtual assistant of the customer support center upon resolution of the issue experienced by the user.

8. The method of claim 1, wherein said user interactions include a user frustration level.

9. The mobile device of claim 11, wherein said user interactions include a user frustration level.

10. The method of claim 1, wherein data corresponding to the set of user interactions include information that identifies a user of the mobile device.

11. A mobile device comprising:
a bus system;
a storage device connected to the bus system, wherein the storage device stores program instructions; and
a processor connected to the bus system, wherein the processor executes the program instructions to:
receive a set of user interactions with the mobile device, wherein said user interactions include previously recorded user voice inputs; and
automatically compose a conversation with an interactive voice response system based on the received set of user interactions with the mobile device.

12. The mobile device of claim 11, wherein automatically composing the conversation with the interactive voice response system based on the received set of user interactions with the mobile device comprises the processor executing the program instructions to:
access the interactive voice response system, wherein the interactive voice response system includes a hierarchy of data structures associated with resolving issues corresponding to the set of user interactions;
parse the set of user interactions based on natural language processing;
classify each respective user interaction in the set of user interactions into a corresponding data structure of the hierarchy of data structures based on parsing the set of user interactions; and
traverse the hierarchy of data structures by automatically providing information associated with each respective classified user interaction to its corresponding data structure in the hierarchy of data structures.

13. The mobile device of claim 12, wherein the processor further executes the program instructions to:
receive responses from the interactive voice response system regarding the issues corresponding to the set of user interactions based on results of traversing the hierarchy of data structures; and
present the responses from the interactive voice response system to a user of the mobile device.

14. The mobile device of claim 11, wherein the processor further executes the program instructions to:
monitor current user interactions with the mobile device while a user performs a set of tasks on the mobile device using a plurality of data input streams on the mobile device; and
determine whether the user is experiencing an issue while performing a task in the set of tasks based on the current user interactions.

15. The mobile device of claim 14, wherein the processor further executes the program instructions to:
automatically establish a network connection with a customer support center corresponding to the issue experienced by the user while performing the task in response to determining that the user is experiencing the issue while performing the task in the set of tasks;
automatically establish a session with a virtual assistant of the customer support center upon establishing the network connection;
initiate a request for information regarding action steps to resolve the issue via conversation structuring with the virtual assistant of the customer support center;
receive the information regarding the action steps to resolve the issue from the virtual assistant of the customer support center; and
apply the action steps to an application of the mobile device corresponding to the task to automatically resolve the issue experienced by the user.

16. A computer program product comprising a computer readable storage medium having program instructions embodied therewith, the program instructions executable by a processor to cause the processor to perform a method comprising:
receiving, by a proxy virtual agent, a set of user interactions with a mobile device, wherein said user interactions include previously recorded user voice inputs; and
automatically composing, by the proxy virtual agent, a conversation with an interactive voice response system based on the received set of user interactions with the mobile device, wherein the proxy virtual agent is operable on the mobile device separate from the interactive voice response system.

17. The computer program product of claim 16, wherein the automatically composing, by the proxy virtual agent, the conversation with the interactive voice response system based on the received set of user interactions with the mobile device comprises:
accessing, by the proxy virtual agent, the interactive voice response system, wherein the interactive voice response system includes a hierarchy of data structures associated with resolving issues corresponding to the set of user interactions;
parsing, by the proxy virtual agent, the set of user interactions based on natural language processing;
classifying, by the proxy virtual agent, each respective user interaction in the set of user interactions into a corresponding data structure of the hierarchy of data structures based on the parsing of the set of user interactions; and
traversing, by the proxy virtual agent, the hierarchy of data structures by automatically providing information associated with each respective classified user interaction to its corresponding data structure in the hierarchy of data structures.

18. The computer program product of claim 17 further comprising:
receiving, by the proxy virtual agent, responses from the interactive voice response system regarding the issues corresponding to the set of user interactions based on results of the traversing of the hierarchy of data structures; and
presenting, by the proxy virtual agent, the responses from the interactive voice response system to a user of the mobile device.

19. The computer program product of claim 16 further comprising:
monitoring, by the proxy virtual agent, current user interactions with the mobile device while a user performs a set of tasks on the mobile device using a plurality of data input streams on the mobile device; and
determining, by the proxy virtual agent, whether the user is experiencing an issue while performing a task in the set of tasks based on the current user interactions.

20. The computer program product of claim 19 further comprising:
responsive to the proxy virtual agent determining that the user is experiencing the issue while performing the task in the set of tasks, automatically establishing, by the proxy virtual agent, a network connection with a customer support center corresponding to the issue experienced by the user while performing the task;
automatically establishing, by the proxy virtual agent, a session with a virtual assistant of the customer support center upon establishing the network connection;
initiating, by the proxy virtual agent, a request for information regarding action steps to resolve the issue via conversation structuring by the proxy virtual agent with the virtual assistant of the customer support center;
receiving, by the proxy virtual agent, the information regarding the action steps to resolve the issue from the virtual assistant of the customer support center; and
applying, by the proxy virtual agent, the action steps to an application of the mobile device corresponding to the task to automatically resolve the issue experienced by the user.
